(19) United States
(12) Patent Application Publication
(10) Pub. No.: US 2009/0289801 A1
(43) Pub. Date: Nov. 26, 2009

(54) INTELLIGENT POWER SUPPLY APPARATUS

(75) Inventors: Cheng-Yi Lo, Taoyuan Hsien (TW); So-Huang Hsieh, Taoyuan Hsien (TW); Tsung-Ting Wu, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/181,048

(22) Filed: Jul. 28, 2008

(30) Foreign Application Priority Data
May 22, 2008 (TW) 097118939

(51) Int. Cl. G08B 21/18

(52) U.S. Cl. 340/584; 340/660; 340/653

(57) ABSTRACT

An intelligent power supply apparatus includes a power converting circuit, one or more sensors, an audio processor, an operating status processor, a storage unit and a loudspeaker. The power converting circuit is used for converting an input voltage into a regulated DC output voltage. The sensors detect operating statuses of the intelligent power supply apparatus, thereby generating corresponding sensing signals. The audio data are processed by the audio processor. The operating status processor is electrically connected to the sensors and the audio processor for controlling the audio processor to generate corresponding output audio signals in response to the sensing signals. The storage unit is electrically connected to the audio processor and/or the operating status processor for storing therein audio data. The loudspeaker is electrically connected to the audio processor for generating audio prompts corresponding to the output audio signals.

### FIELD OF THE INVENTION

The present invention relates to a power supply apparatus, and more particularly to an intelligent power supply apparatus.

### BACKGROUND OF THE INVENTION

Power supply apparatuses are essential for many electronic appliances such as personal computers, industrial computers, servers, communication products or network products. Usually, the user may simply plug a power supply apparatus into an AC wall outlet commonly found in most homes or offices so as to receive an AC voltage. The power supply apparatus will convert the AC voltage into a regulated DC output voltage for powering the electronic device and/or charging a battery built-in the electronic device.

Generally, power supply apparatuses are classified into two types, i.e. linear power supply apparatuses and switching power supply (SPS) apparatuses. A linear power supply apparatus principally comprises a transformer, diode rectifier and a capacitor filter. The linear power supply apparatus is advantageous due to its simplified circuitry and low fabricating cost. Since the linear power supply apparatus has bulky volume, the linear power supply apparatus is not applicable to a slim-type electronic device. In addition, the converting efficiency of the linear power supply apparatus is too low to comply with the power-saving requirements. In comparison with the linear power supply apparatus, the switching power supply apparatus has reduced volume but increased converting efficiency. That is, the switching power supply apparatus is applicable to the slim-type electronic device and may meet with the power-saving requirements.

For normal operations of the linear or switching power supply apparatuses, stability and reliability are very important factors. After the power supply apparatus has been used for a certain period, some components included in the power supply apparatus are possibly malfunctioned or damaged and thus the power supply apparatus eventually has a breakdown. Conventionally, the user doesn't realize the breakdown of the power supply apparatus until the power supply apparatus fails to be operated. In addition, even the maintenance worker needs equipment or a troublesome testing procedure to realize whether the operating conditions of the power supply apparatus are unstable.

There is a need of a providing an intelligent power supply apparatus to obviate the drawbacks encountered from the prior art.

### SUMMARY OF THE INVENTION

It is an object of the present invention to provide an intelligent power supply apparatus whose operating statuses may be easily realized by periodically generating operating prompts.

Another object of the present invention provides an intelligent power supply apparatus capable of generating warning prompts to notify the user of the malfunction of the intelligent power supply apparatus.

A further object of the present invention provides an intelligent power supply apparatus communicable with an external processing device so as to transmit output audio signals to the external processing device.

In accordance with an aspect of the present invention, there is provided an intelligent power supply apparatus. The intelligent power supply apparatus includes a power converting circuit, one or more sensors, an audio processor, an operating status processor, a storage unit and a loudspeaker. The power converting circuit is used for converting an input voltage into a regulated DC output voltage. The sensors detect operating statuses of the intelligent power supply apparatus, thereby generating corresponding sensing signals. The audio data are processed by the audio processor. The operating status processor is electrically connected to the sensors and the audio processor for controlling the audio processor to generate corresponding output audio signals in response to the sensing signals. The storage unit is electrically connected to the audio processor and/or the operating status processor for storing therein audio data. The loudspeaker is electrically connected to the audio processor for generating audio prompts corresponding to the output audio signals.

In accordance with another aspect of the present invention, there is provided an intelligent power supply apparatus. The intelligent power supply apparatus includes a power converting circuit, one or more sensors, an audio processor, an operating status processor, a communication interface and a storage unit. The power converting circuit is used for converting an input voltage into a regulated DC output voltage. The sensors detect operating statuses of the intelligent power supply apparatus, thereby generating corresponding sensing signals. The audio data are processed by the audio processor. The operating status processor is electrically connected to the sensors and the audio processor for controlling the audio processor to generate corresponding output audio signals in response to the sensing signals. The communication interface is interconnected between the intelligent power supply apparatus and an external processing device. The output audio signals are transmitted to the external processing device through the communication interface. The storage unit is electrically connected to the audio processor and/or the operating status processor for storing therein audio data.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating an intelligent power supply apparatus according to a first preferred embodiment of the present invention;

FIG. 2 is a schematic circuit block diagram illustrating an intelligent power supply apparatus according to a second preferred embodiment of the present invention;

FIG. 3 is a schematic circuit block diagram illustrating an intelligent power supply apparatus according to a third preferred embodiment of the present invention; and

FIG. 4 is a schematic circuit block diagram illustrating an intelligent power supply apparatus according to a fourth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

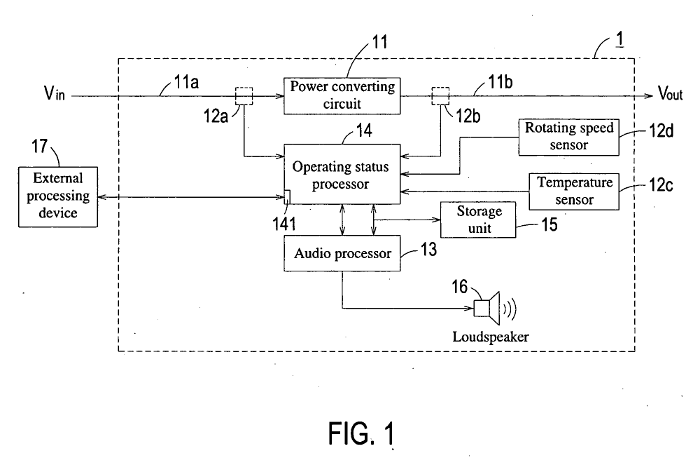

FIG. 1 is a schematic circuit block diagram illustrating an intelligent power supply apparatus according to a first preferred embodiment of the present invention. The intelligent power supply apparatus 1 of FIG. 1 principally comprises a power converting circuit 11, several sensors 12, an audio processor 13, an operating status processor 14, a storage unit 15 and a loudspeaker 16. An input voltage Vin (e.g. an AC voltage or a DC voltage) is received from an input end 11a of the power converting circuit 11. By the power converting circuit 11, the input voltage Vin is converted into a regulated DC output voltage Vout required for powering a load (e.g. an electrical appliance or a motherboard of a computer system). By detecting operating statuses of the intelligent power supply apparatus 1, the sensors 12 issues corresponding sensing signals. Examples of the operating statuses of the intelligent power supply apparatus 1 include but are not limited to the input voltage/current of the power converting circuit 11, the output voltage/current of the power converting circuit 11, the operating temperature, the fan's rotating speed, and so on. The operating status processor 14 is electrically connected to the sensors 12 and the audio processor 13. The storage unit 15 is electrically connected to the audio processor 13 and/or the operating status processor 14 for storing therein audio data and/or application programs. The audio processor 13 is used for converting/decoding digital input audio data into output audio signals or converting/encoding audio signals into digital input audio data. In response to the sensing signals, the operating status processor 14 controls the audio processor 13 to generate corresponding output audio signals. The loudspeaker 16 is electrically connected to the audio processor 13 for generating audio prompts corresponding to the output audio signals.

In this embodiment, the storage unit 15 is electrically connected to both of the audio processor 13 and the operating status processor 14. The storage unit 15 includes a memory and a memory access (not shown). An example of the memory of the storage unit 15 includes an EEPROM (Electrically Erasable Programmable Read-Only Memory), a flash memory or a ROM (Read-Only Memory).

By detecting operating statuses of the intelligent power supply apparatus 1, the sensors 12 issues corresponding sensing signals. In this embodiments, the sensors 12 includes an input voltage/current sensor 12a , an output voltage/current sensor 12b , a temperature sensor 12c and a rotating speed sensor 12d for sensing the input voltage/current of the power converting circuit 11, the output voltage/current of the power converting circuit 11, the operating temperature and the fan's rotating speed, respectively. The input voltage/current sensor 12a and an output voltage/current sensor 12b are respectively arranged in the input end 11a and the output end 11b of the power converting circuit 11. In receipt of the sensing signals, the operating status processor 14 will discriminate whether the intelligent power supply apparatus 1 has a malfunction such as abrupt voltage increase of the input voltage Vin, abrupt increase of the current inputting into the power converting circuit 11, an abrupt voltage increase of the DC output voltage Vout, an abrupt increase of the current outputting from the power converting circuit 11, a very high operating temperature or a very low fan's rotating speed. If the malfunction occurs, the operating status processor 14 will control the audio processor 13 to read out corresponding audio data stored in the storage unit 15. The audio data are then converted or decoded into corresponding output audio signals by the audio processor 13. In response to the output audio signals, the loudspeaker 16 generates corresponding audio prompts. In some embodiments, the audio prompts generated by the loudspeaker 16 are warning prompts to notify the user of the malfunction of the intelligent power supply apparatus 1. The warning prompts have contents indicating for example “abrupt increase of the input voltage”, “abrupt increase of input current”, “abrupt increase of the DC output voltage”, “abrupt increase of the output current”, “a very high operating temperature” or “a very low fan's rotating speed”. The warning prompts will help the user to realize that the intelligent power supply apparatus 1 has a specified malfunction.

In this embodiment, the application programs stored in the storage unit 15 are executed by the operating status processor 14 in order to implement associated functions. Moreover, for implement different functions, the application programs may be modified. Moreover, in addition to the warning prompts, the audio prompts generated by the loudspeaker 16 are operating prompts indicating preset operating conditions of the intelligent power supply apparatus 1 even if no malfunction occurs. The operating prompts are periodically generated and have contents indicating for example “the operating duration from startup of the intelligent power supply apparatus”, “the present input voltage”, “the present input current”, “the present output voltage”, “the present output current”, “the present operating temperature” and “the present fan's rotating speed”. For example, the loudspeaker 16 may generate operating prompts “the operating duration from startup of the intelligent power supply apparatus is two hours” or the like.

In some embodiments, the intelligent power supply apparatus 1 further comprises a communication interface 141. The communication interface 141 is communicated with an external processing device 17 such as a computer system or a motherboard of a computer system. Via the communication interface 141, the messages associated with the operating statuses, including for example the operating duration from startup of the intelligent power supply apparatus, the present input voltage, the present input current, the present output voltage, the present output current, the present operating temperature and the present fan's rotating speed, will be transmitted to the external processing device 17. As a consequence, the messages associated with the operating statuses may be shown on a monitor of the external processing device 17 or issued by another loudspeaker of the external processing device 17 in real time. Furthermore, the audio data stored in the storage unit 15 may be refreshed by the external processing device 17 through the communication interface 141.

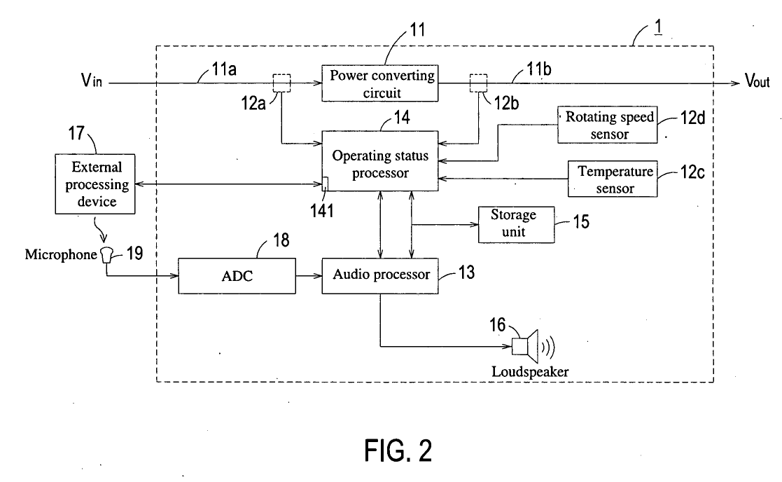

FIG. 2 is a schematic circuit block diagram illustrating an intelligent power supply apparatus according to a second preferred embodiment of the present invention. The intelligent power supply apparatus 1 of FIG. 2 principally comprises a power converting circuit 11, several sensors 12, an audio processor 13, an operating status processor 14, a storage unit 15, a loudspeaker 16, an analog-to-digital converter (ADC) 18 and a microphone 19. The operation principles of the power converting circuit 11, the sensors 12, the audio processor 13, the operating status processor 14, the storage unit 15 and the loudspeaker 16 included in FIG. 2 are similar to those shown in FIG. 1, and are not redundantly described herein. The analog-to-digital converter 18 is electrically connected to the audio processor 13 for converting analog input audio signals into digital input audio signals. The microphone 19 is electrically connected to the analog-to-digital converter 18 for converting sounds into analog input audio signals. Via the microphone 19, the audio data stored in the storage unit 15 may be refreshed or new audio data may be stored in the storage unit 15. In some embodiments, the audio processor 13 may execute the function of converting analog signals into digital signals. Under this circumstance, the analog-to-digital converter 18 may be omitted and the microphone 19 is directly connected to the audio processor 13.

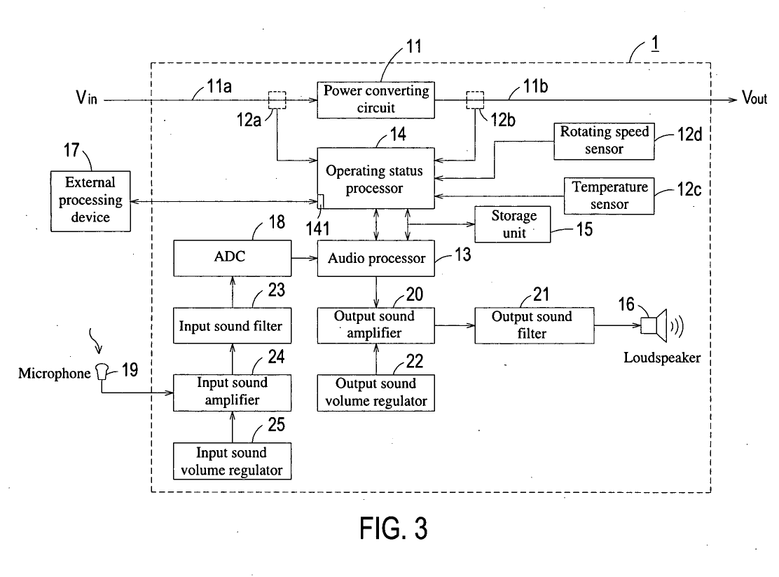

FIG. 3 is a schematic circuit block diagram illustrating an intelligent power supply apparatus according to a third preferred embodiment of the present invention. The intelligent power supply apparatus 1 of FIG. 3 principally comprises a power converting circuit 11, several sensors 12, an audio processor 13, an operating status processor 14, a storage unit 15, a loudspeaker 16, an analog-to-digital converter (ADC) 18, a microphone 19, an output sound amplifier 20, an output sound filter 21, an output sound volume regulator 22, an input sound filter 23, an input sound amplifier 24, and an input sound volume regulator 25. The operation principles of the power converting circuit 11, the sensors 12, the audio processor 13, the operating status processor 14, the storage unit 15, the loudspeaker 16, the analog-to-digital converter 18 and the microphone 19 included in FIG. 3 are similar to those shown in FIG. 2, and are not redundantly described herein. The output sound amplifier 20 is electrically connected to the audio processor 13 for amplifying the output audio signals generated by the audio processor 13. The output sound filter 21 is electrically connected to the output sound amplifier 20 for filtering off undesired noise contained in the amplified output audio signals. The loudspeaker 16 is electrically connected to the output sound filter 21. In response to the amplified and filtered output audio signals, the loudspeaker 16 generates corresponding audio prompts. In addition, the output sound volume regulator 22 is electrically connected to the output sound amplifier 20 for adjusting the sound volume of the amplified output audio signals generated by the output sound amplifier 20. The input sound amplifier 24 is electrically connected to the microphone 19 for amplifying the analog input audio signals generated by the microphone 19. The input sound filter 23 is electrically connected to the input sound amplifier 24 for filtering off undesired noise contained in the amplified analog input audio signals. The analog-to-digital converter 18 is electrically connected to the input sound filter 23 and the audio processor 13 for converting the amplified and filtered analog input audio signals into digital input audio signals. The input sound volume regulator 25 is electrically connected to the input sound amplifier 24 for adjusting the sound volume of the amplified analog input audio signals generated by the input sound amplifier 24.

In some embodiments, the layout configurations of the output sound amplifier 20, the output sound filter 21, the output sound volume regulator 22, the input sound filter 23, the input sound amplifier 24, and the input sound volume regulator 25 may be varied as required.

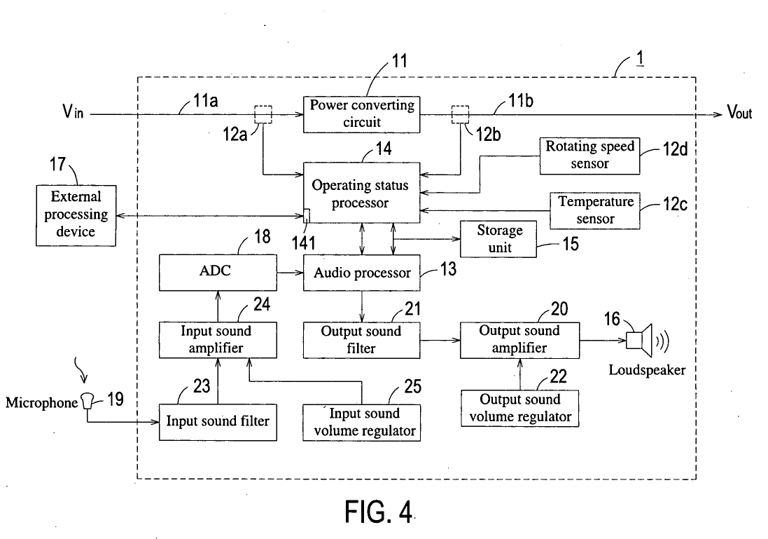

FIG. 4 is a schematic circuit block diagram illustrating an intelligent power supply apparatus according to a fourth preferred embodiment of the present invention. The operation principles of the components 11˜25 included in FIG. 4 are similar to those shown in FIG. 3, and are not redundantly described herein. The output sound filter 21 is electrically connected to the audio processor 13 for filtering off undesired noise contained in the output audio signals generated by the audio processor 13. The output sound amplifier 20 is electrically connected to the output sound filter 21 for amplifying the filtered output audio signals. The loudspeaker 16 is electrically connected to the output sound amplifier 20. In response to the filtered and amplified output audio signals, the loudspeaker 16 generates corresponding audio prompts. In addition, the output sound volume regulator 22 is electrically connected to the output sound amplifier 20 for adjusting the sound volume of the filtered and amplified output audio signals generated by the output sound amplifier 20. The input sound filter 23 is electrically connected to the microphone 19 for filtering off undesired noise contained in the analog input audio signals generated by the microphone 19. The input sound amplifier 24 is electrically connected to the input sound filter 23 for amplifying the filtered analog input audio signals. The analog-to-digital converter 18 is electrically connected to the input sound amplifier 24 for converting the amplified and filtered analog input audio signals into digital input audio signals. The input sound volume regulator 25 is electrically connected to the input sound amplifier 24 for adjusting the sound volume of the amplified analog input audio signals generated by the input sound amplifier 24.

From the above description, the operating statuses of the intelligent power supply apparatus of the present invention may be realized by the user because operating prompts are periodically generated. Moreover, in a case that the intelligent power supply apparatus has a malfunction, warning prompts are generated to notify the user of the malfunction of the intelligent power supply apparatus. In other words, neither additional equipment nor troublesome testing procedure is required to realize whether the operation of the power supply apparatus is unstable. Before the malfunction becomes serious or irrecoverable, the user may take appropriate measures to replace the intelligent power supply apparatus with a new one or backup data in the computer system. Moreover, the operating statuses of the intelligent power supply apparatus may be transmitted to the external processing device via the communication interface. As a consequence, the messages associated with the operating statuses may be shown on a monitor of the external processing device or issued by another loudspeaker of the external processing device in real time.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An intelligent power supply apparatus comprising:
a power converting circuit for converting an input voltage into a regulated DC output voltage;
one or more sensors for detecting operating statuses of said intelligent power supply apparatus, thereby generating corresponding sensing signals;
an audio processor for processing audio data;
an operating status processor electrically connected to said sensors and said audio processor for controlling said audio processor to generate corresponding output audio signals in response to said sensing signals;
a storage unit electrically connected to said audio processor and/or said operating status processor for storing therein audio data; and
a loudspeaker electrically connected to said audio processor for generating audio prompts corresponding to said output audio signals.

2. The intelligent power supply apparatus according to claim 1 wherein if said intelligent power supply apparatus has a malfunction, said audio prompts are warning prompts to notify the user of said malfunction.

3. The intelligent power supply apparatus according to claim 1 wherein if no malfunction of said intelligent power supply apparatus occurs, said audio prompts are operating prompts to indicate present operating conditions of said intelligent power supply apparatus.

4. The intelligent power supply apparatus according to claim 1 wherein one of said sensors is an input voltage/current sensor for sensing an input voltage/current of said power converting circuit.

5. The intelligent power supply apparatus according to claim 1 wherein one of said sensors is an output voltage/current sensor for sensing an output voltage/current of said power converting circuit.

6. The intelligent power supply apparatus according to claim 1 wherein one of said sensors is a temperature sensor for sensing an operating temperature of said intelligent power supply apparatus.

7. The intelligent power supply apparatus according to claim 1 wherein one of said sensors is a rotating speed sensor for sensing a fan's rotating speed of said intelligent power supply apparatus.

8. The intelligent power supply apparatus according to claim 1 wherein said storage unit comprises a memory and a memory access.

9. The intelligent power supply apparatus according to claim 8 wherein said memory is a flash memory or a read-only memory.

10. The intelligent power supply apparatus according to claim 1 wherein said operating status processor further comprises a communication interface and said output audio signals are transmitted to an external processing device through said communication interface.

11. The intelligent power supply apparatus according to claim 10 wherein said audio data stored in said storage unit is refreshed by said external processing device through said communication interface.

12. The intelligent power supply apparatus according to claim 1 further comprising a microphone, which is communicated with said audio processor, for converting sounds into analog input audio signals.

13. The intelligent power supply apparatus according to claim 12 further comprising an analog-to-digital converter, which is interconnected between said microphone and said audio processor, for converting said analog input audio signals into digital input audio signals.

14. The intelligent power supply apparatus according to claim 13 further comprising an input sound amplifier, which is interconnected between said microphone and said analog-to-digital converter, for amplifying said analog input audio signals generated by said microphone.

15. The intelligent power supply apparatus according to claim 14 further comprising an input sound volume regulator, which is electrically connected to said input sound amplifier, for adjusting a sound volume of said amplified analog input audio signals generated by said input sound amplifier.

16. The intelligent power supply apparatus according to claim 13 further comprising an input sound filter, which is interconnected between said microphone and said analog-to-digital converter, for filtering off noise contained in said analog input audio signals.

17. The intelligent power supply apparatus according to claim 1 further comprising an output sound amplifier, which is interconnected between said audio processor and said loudspeaker, for amplifying said output audio signals.

18. The intelligent power supply apparatus according to claim 17 further comprising an output sound volume regulator, which is electrically connected to said out sound amplifier, for adjusting a sound volume of said amplified output audio signals generated by said output sound amplifier.

19. The intelligent power supply apparatus according to claim 17 further comprising an output sound filter, which is interconnected between said audio processor and said loudspeaker, for filtering off noise contained in said output audio signals.

20. An intelligent power supply apparatus comprising:
a power converting circuit for converting an input voltage into a regulated DC output voltage;
one or more sensors for detecting operating statuses of said intelligent power supply apparatus, thereby generating corresponding sensing signals;
an audio processor for processing audio data;
an operating status processor electrically connected to said sensors and said audio processor for controlling said audio processor to generate corresponding output audio signals in response to said sensing signals;
a communication interface interconnected between said intelligent power supply apparatus and an external processing device, wherein said output audio signals are transmitted to said external processing device through said communication interface; and
a storage unit electrically connected to said audio processor and/or said operating status processor for storing therein audio data.
